(19) United States
(12) Patent Application Publication
(10) Pub. No.: US 2006/0007508 A1
(43) Pub. Date: Jan. 12, 2006

(54) Epicyclic scanning device

(75) Inventor: Chun-Tao Huang, Ban-Chao City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MUSTEK SYSTEMS INC.

(21) Appl. No.: 10/886,563

(22) Filed: Jul. 9, 2004

(51) Int. Cl. H04N 1/04

(52) U.S. Cl. 358/497

(57) ABSTRACT

The present invention relates to a epicyclic scanning device including a document tray to hold the documents, a rotation shaft for rotating motion, a transmission mechanism joining together with the rotation shaft for circular motion, and an image scanning unit which is to scan the documents on the document tray when the transmission mechanism drive the document stand in the planetary motion, wherein the image scanning unit includes: a scanning light source, a lens group consisting of mirrors and lenses and a image sensing unit.

### BACKGROUND OF THE INVENTION

1. Field of the Invention

The present invention relates to an optical scanning device, particularly to a design of scanning documents in epicyclic movement.

2. Background Description

Referring to FIG. 1 and FIG. 2 for the three-dimension drawings of the known flat scanning device, generally the known platform style scanning device is mostly the platform style desktop CCD optical scanner. The operation is: first, place the platform style scanner unit 11 on table; next, place the document to be scanned in the scanning area; close the upper cover 12; then, get connected with a computer via cable; afterward, plug the power cord in the electric outlet, push the button and start to scan.

The circuit structures of both the known traditional platform style optical scanner and the innovation of the present invention mainly relates to a scanning device, which is able to link with a computer to process the output of the image signal; wherein the CCD (Charge Couple Device) in the image sensing unit senses to drive, via a built-in analog multiplexer, the analog signal is asynchronously output, next the CCD enlarging converter magnifies the image signal and offsets the direct current, afterward via a analog/digital converter, the asynchronous analog signal is converted into the storable digital image signal, finally the image signal is saved in memory buffer, and the position control device controls the mirror and the position of the lamp to scan the document waiting to be scanned. Briefly, the known optical scanning technique is: using CCD sensor to sense to drive, the analog signal is asynchronously output driven by a built-in analog multiplexer, the direct current is offset by a voltage converter in order to acquire the more precise waveform, next magnifying the image signal prevents the interruption, then the analog signal is converted into the digital image signal and saved into a memory buffer, position control device controls the mirror and the position of the lamp to scan the document waiting to be scanned.

As for mechanism structure, the scanning structure of the known traditional platform style scanner is a desktop optical scanning structure. The known desktop scanner takes CCD (Charge Couple Device) optical scanning device using cathode lamp for the light source as the main unit to scan the documents. Regarding the scanner nowadays, though the optical scanning unit generally called CIS (Contact Image Sensor) has replaced CCD, there still exist the space and usage limitation of the structure of the known traditional platform scanner, such as occupy too much the applicable space, need to be placed on table, inconvenient to be carried around and so on; therefore, the inventor proposed the present invention, the character of the present invention is right to improve the known traditional bulky voluminous platform style scanner's drawbacks of wasting the applicable space and inconvenient usage and storage. As shown in FIG. 2, the traditional scanner has to be placed horizontally on table, with the driving device 21 being propelled by the driving unit 22, the optical sensing unit 24 in accord with the linear style transmission shaft 23 scans in linear way.

### SUMMARY OF THE INVENTION

In view of the drawbacks of the structure of the known traditional platform scanner stated above, the primary purpose of the present invention is to greatly reduce the occupied space while scanning with the structure of the curvilinear optical scanning. The dimension of the scanner unit is not restricted by the paper size anymore, for instance, a normal size scanner can not scan a letter size paper popular in Western in single time; it is a shortcoming of the typical scanning device in linear motion.

Especially for a common user, the applicable horizontal space on or under table is limited, the present invention is able to break the traditional styling of the scanner, so that the scanner unit can be vertically up extended; that is, the scanning motion is changed from linear to curvilinear in order to save the applicable space. In addition, because the curvilinear style scanner is much smaller, easy to be carried and effortless to be manufactured, the present invention also achieves the secondary purpose of the manufacturing cost down, convenient usage and easy storage.

Moreover, the special chain motion mechanism can be designed into the epicyclic or planetary style scanner to drive the optical sensing unit, thus, the scanner can also scan the articles with irregular curves, in particular to scan in circular motion of rolling on the circumference of the article's waist; furthermore, the present invention can perform the continuous or discontinuous multi-curve scanning.

It is the object to provide an optical scanning device, particularly to a design of scanning in planetary circular motion driven by a motor; wherein it only needs to start a motor built on an shaft in a roller, the optical scanner built on the roller scan in planetary circular motion driven by a brace, further the optical scanner's cathode lamp scanning enters from the opening outside the roller into a cylindrical document tunnel. The character of the present invention is primarily to improve the drawbacks of the known bulky voluminous platform style scanner, such as waste of the applicable space and the inconvenient usage, further to advance to the method of optical scanning in cylindrical structure, finally to accomplish the purposes of saving space, handy in use and easy storage.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is the three-dimension drawing showing the known platform style scanning device;

FIG. 2 is the top view of the internal structure of the known platform style scanning device;

FIG. 3 is the top view of the first embodiment of the present invention;

FIG. 4 is the three-dimension diagram of the first exemplary implementation of the present invention;

FIG. 5 is the three-dimension diagram of the second embodiment of the present invention; and

FIG. 6 is the three-dimension diagram of the third embodiment of the present invention;

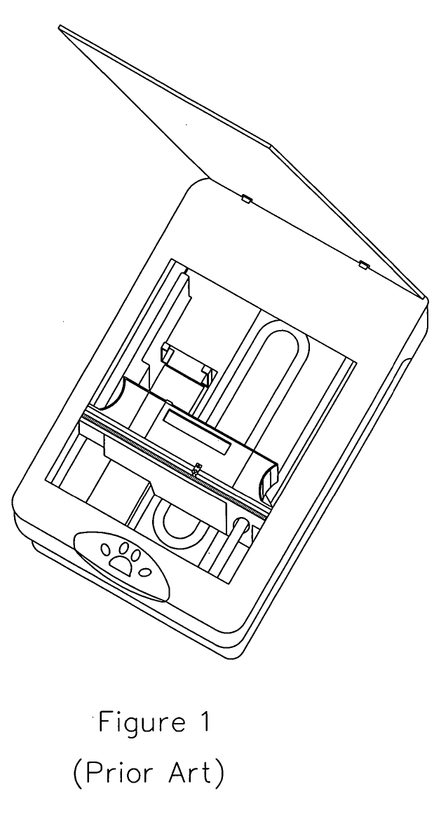

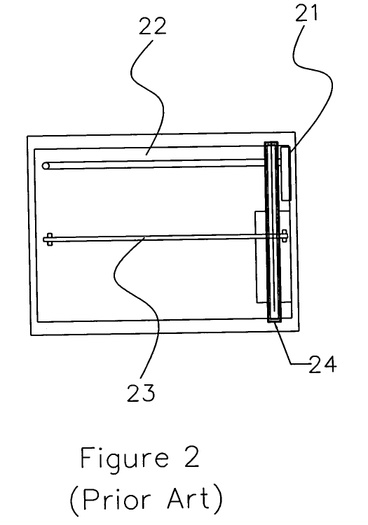

### DETAILED DESCRIPTION OF A PREFERRED EMBODIMENT OF THE INVENTION

In order to provide a clear description and better understanding, charts/diagrams are not drawn in portion and relative scale. The size of some parts is also exaggerated compared in scale to other related parts. To be more concise, irrelative details are not drawn completely.

The present invention is mainly to improve the structure of the known traditional desktop optical scanning device.

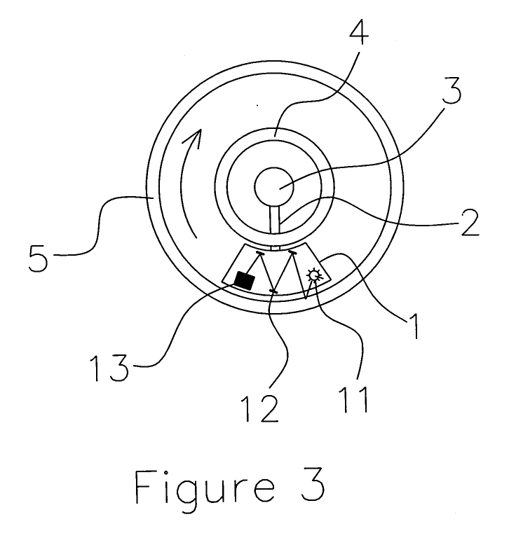

As for FIG. 3, it is the first exemplary embodiment of the present invention and it relates to a planetary optical scanning structure. The circular motion structure of the cylindrical optical scanning device includes: an image scanning unit 71, a transmission mechanism 72, a shaft 73, a brace 74 and a document stand 75. The document stand 75 is made with transparent glass or the other glassy materials, so the document is rolled around the document stand 75 to be scanned by the image scanning unit 71. The shaft 73 is driven by a motor (not shown in the drawing) for circular motion; with the transmission mechanism 72 (as a lever shown in the drawing), the image scanning unit, facing the document stand 75, can scan back and forth in circular motion; so a document around the document stand 75 can be scanned. If setting up another mechanism to rotate the document, and theoretically operating with the image scanning unit in the successional chain motion, so it can scan long paper documents such as drawings or Chinese calligraphy and painting. Besides, to enhance the stability of the image scanning unit in circular motion, the extra brace 74 is built up on the transmission mechanism 72 to support and constrain its radial moves. Certainly, the brace also can be built up on the image scanning unit 71 to stabilize the whole scanning process.

Additionally, the present invention proposed that in the image scanning unit 71 there are installed with: a scanning light source 81, a lens group 82 and an image sensor 83. The scanning light source 81 offers the light needed for scanning; the light beams passing thru the document stand 75 get onto the document then get reflected into the lens group; after the proper reflecting and focusing effect, the light beams get into the image sensor 83, so it generates the scanned image signal and outputs to the signal processor at back end (not shown in the drawing) for the following operations. Other than being installed in the image scanning unit as the present invention proposed, the scanning light source 81 can be installed in somewhere else, for example, on the shaft in synchronal motion. Furthermore, the lens group 82 can consist of numerous mirrors or lenses; and CCD (Charge Couple Device) can be installed inside of the image sensor 83.

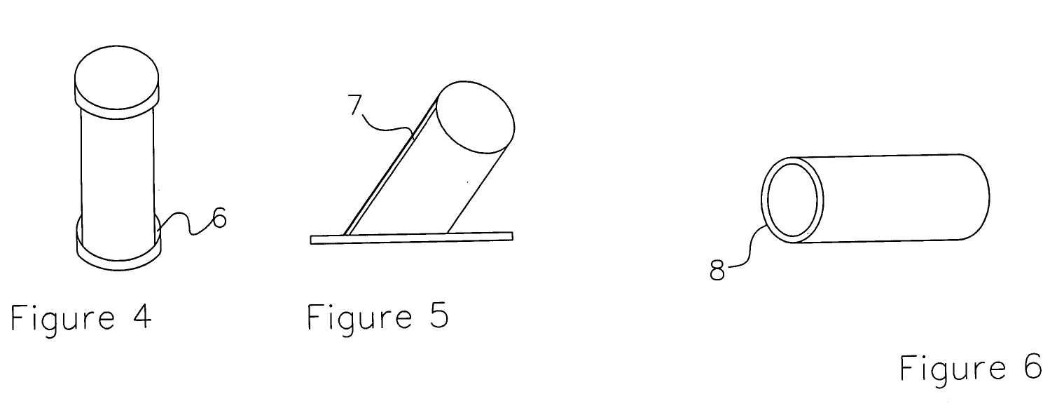

Referring to FIG. 4 for the diagram of the first exemplary implementation of the present invention, a document guiding groove 76 is implemented outside the document stand for holding the document to be scanned; the document guiding groove can be on the top or on the bottom or on both ends. The user can place the document in the document guiding groove 76 and activate the scanner; after the scanner completes the planetary scanning in circular motion, the user can directly pull out the documents, hence, it's very convenient in usage. Plus, it is a design of tower style in the exemplary implementation of the present invention, so the required space on top of table and storage room is much less.

Referring to FIG. 5 for the diagram of the second exemplary implementation of the present invention, the invention of placing the scanner obliquely shows the superior space usage; when the applicable space is limited, the scanner can be placed obliquely; coordinating the ergonomics design for the office environment, the present invention proposed to set up a base on the bottom so that it can be placed independently but no need to rely on the other objects. As for the implementation of document setting, it is feasible to deploy an opening for placing document 77. Coupling with the setting of the document rotating mechanism as previously stated, when a document is placed in the opening 77, the document rotating mechanism can bring the document into the document stand; when planetary scan in circular motion is finished, the document rotating mechanism can even bring the scanned document out; meanwhile, the un-scanned portion will be brought in the document stand; therefore, the banner-like document, the calligraphy and painting can be scanned.

Referring to FIG. 6 for the diagram of the third exemplary implementation of the present invention, the invention can be placed horizontally to comply with the limitation of actual space, such as on the cashier counter. In this exemplary implementation, the design of document tunnel 78 allows a user to roll a document and to put into the tunnel for scanning process, and to be retrieved when it's done scanning; so it's very convenient and human oriented.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. A scanning device comprising:
a document stand for holding a document to be scanned;
a shaft for conveying a rotating motion;
a transmission mechanism, connected with said shaft and for conducting a circular motion; and
an image scanning unit, driven by said transmission mechanism in a planetary motion on said document stand, for scanning said document on the other side of said document stand.

2. The scanning device of claim 1, wherein said image scanning unit comprises a light source, a lens group and an image sensor.

3. The scanning device of claim 2, wherein said image sensor is a charge-coupled device for outputting image signal.

4. The scanning device of claim 1, further comprising includes a brace to enhance the stability of said image scanning unit while conducts scanning.

5. The scanning device of claim 4, wherein said brace is set up on said transmission mechanism.

6. The scanning device of claim 4, wherein said brace is set up on said image scanning unit.

7. The scanning device of claim 2, wherein said lens group comprises a mirror.

8. The scanning device of claim 2, wherein said lens group comprises lenses.

9. A planetary scanning device comprising:
a shaft for conveying rotating motion;
a transmission mechanism, connected with said shaft and conducting circular motion;
an image scanning unit, driven by said transmission mechanism in planetary motion on a document stand, for scanning a document placed outside said image scanning unit; and
a light source deployed on said transmission mechanism and for synchronizing movement with said the image scanning unit.

10. The planetary scanning device of claim 9, wherein said image scanning unit comprises a lenses group and an image sensor.

11. The planetary scanning device of claim 9, further comprising a brace to enhance the stability of said image scanning unit in scanning.

12. A scanning device comprising:
a document stand for holding a document to be scanned;
a shaft for conveying rotating motion;
a transmission mechanism, connected with said shaft for conveying circular motion;
an image scanning unit, driven by said transmission mechanism in planetary motion on said document stand for scanning said document on the other side of said document stand; and
a brace for supporting and constraining said transmission mechanism, further enhancing stability of said image scanning unit during conducting scanning.

13. The scanning device of claim 12, wherein said image scanning unit comprises a scanning light source, a lens group and an image sensor.
